(19) United States
(12) Patent Application Publication
(10) Pub. No.: US 2017/0164146 A1
(43) Pub. Date: Jun. 8, 2017

(54) Systems and Methods for Selectively Permitting Information Capture in a Predetermined Geographic Zone

(71) Applicant: Jordan James Eli Coppert, Las Vegas, NV (US)

(72) Inventor: Jordan James Eli Coppert, Las Vegas, NV (US)

(73) Assignee: Jordan James Eli Coppert, Las Vegas, NV (US)

(21) Appl. No.: 15/361,328

(22) Filed: Nov. 25, 2016

Related U.S. Application Data
(60) Provisional application No. 62/263,471, filed on Dec. 4, 2015.

(51) Int. Cl. H04W 4/02; H04W 12/00

(52) U.S. Cl. CPC H04W 4/021; H04W 12/00

(57) ABSTRACT

Methods of selectively permitting the capture of information is disclosed. The methods include determining if a device capable of capturing information has entered a predetermined geographically defined zone, the zone having at least one configurable criterion; determining a parameter of the device; and selectively permitting, if the parameter of the device satisfies the at least one configurable criterion, an ability of the information capturing device to capture information when in the predetermined geographically defined zone. Devices implementing such methods are also disclosed.

### FIELD OF THE INVENTION

This invention relates to systems and methods for selectively permitting information capture in a geographically predetermined zone.

### BACKGROUND OF THE INVENTION

A modern mobile device, typically, has the capability of knowing its location at any given point in time. This makes it desirable to set up predetermined geographically defined zones or geo-fences, which interact with said device when it enters, leaves, or is inside of a geo-fenced area. Existing applications of this technology include mobile device tracking, sending alerts to a device and or other devices detailing its movement, distributing marketing to the user of a device, etc. This might be implemented through a mobile application or wifi network which uses the mobile device's location data and location based services to automatically send out notifications to device users.

Mobile devices are capable of performing functions in response to their entrance, exit, or presence in a geographically defined zone: not just receiving information. The current uses of geo-fencing technology have neglected the most important market demand of the moment: security. With mobile devices being able to instantly capture information through information-gathering features such as cameras, microphones, and screen buffers, the privacy and security desired by businesses and people alike seems to be rapidly disappearing. People may have images taken of them which are unflattering, or private conversations or correspondence recorded. In the corporate and private settings alike, control of confidential Information may easily be lost.

Thus, there is a need in the art for a way to selectively control the of information-gathering features on any number of devices based on their location.

### SUMMARY OF THE INVENTION

A method of selectively permitting the capture of information is described. Embodiments of certain methods described herein, comprise: determining if a device capable of capturing information has entered a predetermined geographically defined zone, the zone having at least one configurable criterion; determining a parameter of the device; and selectively permitting, if the parameter of the device satisfies the at least one configurable criterion, an ability of the information capturing device to capture information when in the predetermined geographically defined zone.

In another aspect, embodiments of the invention provide an information capturing device configured to restrict the capture of information. In certain embodiments, the information capturing device comprises: one or more information capturing features; and a software protocol configured to determine if the information capturing device has entered a geographically restricted zone and to selectively permit an ability of the information capturing device to capture information when in the information capturing device is within the predetermined geographically defined zone.

### BRIEF DESCRIPTION OF THE DRAWINGS

FIG. 1 illustrates a method of selectively permitting information capture according to embodiments of the invention.

FIG. 2 illustrates a security response framework according to an embodiment of the invention.

FIG. 3 illustrates an alteration process according to an embodiment of the invention.

FIG. 4 illustrates a replacement process useful in certain embodiments of the invention.

FIG. 5 illustrates a restriction process useful in certain embodiments of the invention.

FIG. 6 illustrates a process for establishment of a geo-restricted area according to certain embodiments of the invention.

### DETAILED DESCRIPTION

### Definitions

The term “predetermined geographically defined zone” means an area designated by a selected geographic perimeter e.g. radius, polygon, or an irregular shape around one or more points (or areas) of interest. Typically the predetermined geographically defined zone is established prior to information capturing devices interacting with it, and it is also referred to as “geo-restricted” within this document. A predetermined geographically defined zone may be created a variety of ways, one such way as defined in U.S. Pat. No. 7,164,986 by using a mapping application, incorporated herein by reference in its entirety. As described therein a mapping application provides geographical maps of locations with which the tracked device may be tracked. The user can then create and edit the specific geofence in accordance with the user's desires. As also described therein a web server application can include any suitable web server programming that enables access and data exchange with client. For example, the web server application can supply the mapping application in the form of an applet, plug-in, or the like for viewing and/or interaction by a user at client. Once the geofence objects are created, the mapping application resolves the boundaries into a set of coordinates (e.g., longitude and latitude). As shown therein, a geofence creation screen is presented to the client once the mapping application has been accessed and executed. The geofence creation screen as described has four functional sections (but it may have more or fewer depending on the implementation): a mapping section, a reports section, a setup and maintenance section and a help section. A user, located at the client, is able to utilize the tools located in the drawing window to create geofence objects in the mapping section. As discussed in more detail below, the geofence objects can either be circular or polygons and can be grouped in accordance with the user's wishes. In other embodiments, the predetermined geographically defined zone may be as described in U.S. Pat. Nos. 8,396,485; 8,471,701; U.S. Pat. App. Pub. Nos. 2011-250901; 2013-0331118; 2013-0331128; and 2014-0222334, each of which is incorporated herein by reference in its entirety.

The term “altered form” means a modified representation of the digital information captured by information capturing features on an information capturing device that is either obscured such that at least a portion of any material information in the information intended to be captured is rendered illegible. In any embodiment, “altered form” may mean that the modified representation does not convey all, essentially all, or substantially all of the material information of the captured information intended to be captured. Examples might include information having certain elements adding element to e.g. text to the information intended to be captured; removing elements, one or more isolated data points, or groups of data points from information intended to be captured; or obscuring the information intended to be captured, e.g. the blurring by randomization or bitmap editing techniques, of sound or image elements, e.g., faces, word, phrases, or individual letters that may appear in the information intended to be captured, the latter. Certain elements might be added to the information as described in U.S. Pat. No. 6,954,541, incorporated herein by reference in its entirety; elements might be removed from information as described in Erasing Video Logos Based on Image Inpainting by Wei-Qi Yan and Mohan S. Kankanhalli (Yan, W., & Kankanhalli, M. (2002). 2002 IEEE International Conference on Multimedia and Expo proceedings: Aug. 26-29, 2002, Swiss Federal Institute of Technology, Lausanne, Switzerland. (Vol. 2, pp. 521-524). Piscataway, N.J.: IEEE); or existing information changed as described for e.g., in U.S. Pat. Ap. Pub. No. 2005-0190985A1.

The term “disabling an information capturing feature” means limiting access to or restricting the functionality of a camera feature, an audio recording feature, or a screen capture feature on an information capturing device.

The term “configurable criterion” means any element or characteristic which serves as the behavioral determinant and justification for selectively permitting information capturing features in information capturing devices within a geographically defined area. Examples include elements or characteristics of information capturing devices within a geographically defined area, predetermined events happening in or around the point of interest of a geographically defined area, specified durations of time, geographically defined areas overlapping into other geographically defined areas, and similar elements not listed here.

The term “parameter of the device” means a characteristic of an information capturing device, which when compared to the geographically defined area, either matches or does not match the configurable criteria. Examples of such include physical device location, derived device time zone and device time, device ownership, device relation to a geographically defined area or the operating entity of a geographically defined area, as well as other internal and external characteristics of the information gathering device not listed here.

The term “remote storage device” means any location not on the information capturing device such as a secure server or another information capturing device.

The term “image” means a photo or video captured by a camera.

The term “information capturing device” means any device capable of capturing, storing and or electronically transferring information, including but not limited to cellular telephones, tablet type computers, laptop computers, and desktop computers, wearable electronic devices incorporating one or more such devices.

The disclosed methods provide an automated response framework for electronic devices, integrated into operating systems and/or software applications, which aims to selectively affect media gathering functionality of said devices based on configurable criteria. The response framework is capable of altering media from its intended save state, modifying the save location of captured media, and restricting access to media gathering functions entirely.

The response framework can be active at any time based on how it is integrated and implemented into a device's operating system and/or applications. When active, it automatically intervenes to selectively affect media gathering functionalities based on any number of said configurable criteria being met. The possibilities for selectively effecting functionality includes only restricting photos and videos, restricting media gathering functions entirely, or not restricting media gathering functions at all. The most notable of the configurable criteria is restriction based on geographic location of said device in relation to a defined virtual area. The area, being categorized as geo-restricted, is defined using location based technologies such as global positioning system (GPS) to establish a polygon or radius around a point of interest. A device then obtains data regarding its position through location service technologies like GPS, and applies said data to determine its relation in relation to the virtual area. If the device intersects the virtual area, a notification may be sent to the user device to inform the user that they have entered a region where device functionality is selectively limited based on permissions. Media gathering functions including but not limited to capturing images from the screen buffer, capturing audio from the microphone, and capturing photos or video from the camera can be restricted by the response framework. Both the methods of effecting media (alter, replace, or restrict) and types of media affected can be configured.

In accordance with the disclosed methods and which is described in greater detail herein, the configurable criteria and selective permissions can be dynamically modified based on changes to parameters related to at least one of a user of the user device, point of interest, or other external conditions which might affect the prior. The configurable criteria and selective permissions can be dynamically modified based on user device or user of the user device relation (employment, clientele, familial, etc.) to the entity owning a given geo-restricted area. The configurable criteria and selective permissions can be dynamically modified based on specified durations of time. The configurable criteria and selective permissions can be dynamically modified based on predetermined events, e.g., special events, taking place in or near a POI (commercial promotions, national disasters, concerts, etc.). The configurable criteria and selective permissions can be dynamically modified based on overlapping geo-restricted areas or proximity to another geo-restricted area. It is also understood that the configurable criteria and selective permissions can be dynamically modified based on any combination of the any above listed scenarios, and such scenarios are extended to include those not listed above which might be of interest to the operating entity of a geo-restricted area.

As pertaining to applications of the automated response framework, the primary concern is data security. Such a framework would seek to prevent user devices from capturing data or information intended to be private. This data includes but is not limited to private correspondence such as photos or videos, private meetings, government or corporate information and secrets, financial information, and photos of restricted areas. In an attempt to control media capture of this data and subsequent dissemination for purposes other than intended, the framework provides selective limitations on the media gathering components of a device: the camera, the microphone, and the screen buffer.

One of the main mediums by which media is experienced is through images: being defined and referenced throughout the remainder of this document as either photo or video, captured by a camera. As the number of smart devices increase in the world, nearly everyone has the ability to capture images with the camera of their device at any time. This is unwanted in areas or situations where secure information is present, or people desire information to remain unrecorded. For example, pictures being taken of development prototypes at a company test site or a defaming and humiliating video being taken of someone at a party. The framework provides the ability for such areas to be geo-restricted, eliminating the concern that unwanted images are being captured. Images that are captured within the area can be automatically altered to distort and protect the contents, or replaced to prevent user access to the captured files. Access to the camera function may be restricted entirely as well. The method used to affect media gathering is entirely based on the selective abilities of the configurable criteria. Lastly, depending upon the configurable criteria, entities may be notified that a given user and/or user device is attempting to take such action.

A natural extension of media, particularly videos, is audio. Smart devices are almost always equipped with microphones: being necessary for telecommunications among other tasks. As pertaining to private information, this proves even more problematic being that a microphone need not point directly at what the user wants to capture, as is the case with a camera. This makes it easy to discreetly record information, without raising awareness. An example might be a person recording a confidential business meeting, or in junction with a camera, a movie in a theatre. The framework provides the ability for areas where audio recordings are a potential problem to be geo-restricted, eliminating the concern that unwanted recordings are being captured. Audio that is captured within the area can be automatically altered to distort and protect the contents, or replaced to prevent user access to the captured files. Access to the microphone function may be restricted entirely as well. The method used to affect media gathering is entirely based on the selective abilities of the configurable criteria. Lastly, depending upon the configurable criteria, entities may be notified that a given user and/or user device is attempting to take such action.

Lastly, most electronic devices are capable of capturing media from the screen buffer. This doesn't pose a threat to information that might be captured in a device's surroundings, but information being viewed on a screen. Particularly, sensitive documents and web or application pages are of great concern. An example might be the pirating of artwork via the screenshot or printscreen functions. In addition to situations like these, private correspondence is a large concern. For instance, in relationships among younger people, the number private and revealing images being sent digitally has become quite large. The framework provides the ability for these digital spaces to be protected, eliminating the concern in large that information on a screen leaves it in an unwanted fashion. Screen-captures that are taken within the area can be automatically altered to distort and protect the contents, or replaced to prevent user access to the captured files. Access to screen-capture functions may be restricted entirely as well. The method used to affect media gathering is entirely based on the selective abilities of the configurable criteria. Lastly, depending upon the configurable criteria, entities may be notified that a given user and/or user device is attempting to take such action.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

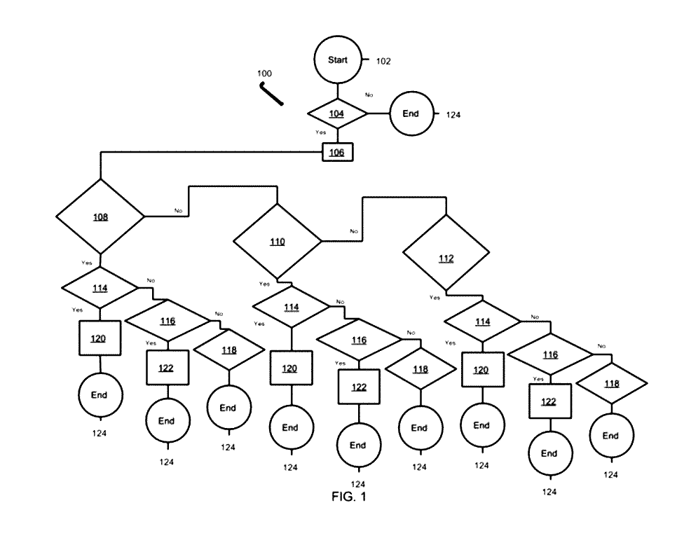

Referring now to FIG. 1, there is schematically represented a process 100 according to embodiments of the invention. The process begins with Start Step 102 which may comprise any number of prior steps or functions. Start Step 102 is followed by Step 104. Step 104 comprises detecting a device capable of capturing information, the device having a given parameter, entering a predetermined geographically defined zone which has at least one configurable criterion. Process 100 also comprises step 106 in which an information capturing ability of the information capturing device is activated that the geo-restricted area of step 104 has not selectively permitted through comparison of the given parameter(s) and criterion. Following step 106 are steps 108, 110, and 112 in which the activated information capturing ability is identified as a camera feature, an audio feature, or a screen capture feature. Process 100 lastly includes one of three ways in which the information gathered by the feature of step 108, 110, or 112 is affected. Step 114 comprises altering the captured information of the information capturing device. Step 120 takes the altered information of Step 114 and stores it on the device. Next, gathered information might be affected by step 116. Step 116 describes storing the information captured by the information capturing ability in a location other than that which was originally intended, such as a remote storage device. Step 122 takes information other than the captured information from step 116 and stores it on the information capturing device. Lastly, Process 100 comprises Step 118 in which an information gathering feature of the device is disabled so that information cannot be captured. The process embodiments of the invention ends at End Step 124. End Step 124 may comprise any number of steps or function performed after Steps 104, 118, 120, or 122.

The techniques of altering media 114 are isolated to circumstance regarding their given application. A specific method is designated through the configurable criteria. For instance, examples of altering media include distorting the pixels of an image, animating a screen buffer to obscure view contents during a capture process, overlapping visual elements to obscure an original image, modifying the display properties—such as opacity and alpha values—of captured media itself or other visual elements intended to obscure or supplement the original image, adjusting audio levels and frequencies, introducing new audio elements into a recording to drown out or muffle the original sound, etc. Other methods of altering media captured from the screen buffer, camera, and microphone exist, but not all are exclusively listed here.

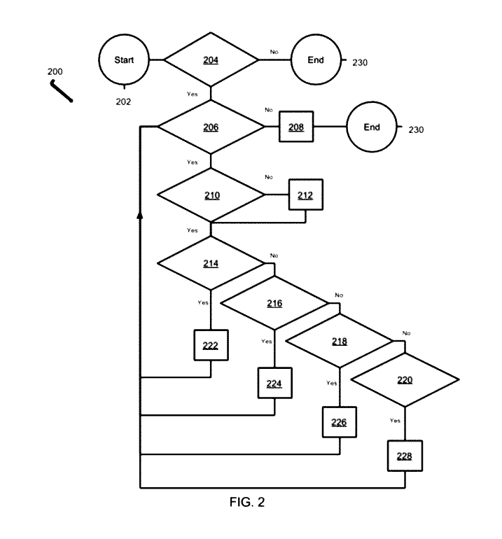

Referring now to FIG. 2, there is schematically represented a process 200 according to embodiments of the invention. The process begins with Start Step 202 which may comprise any number of prior steps or functions. Start Step 202 is followed by Step 204. Step 204 comprises detecting a device capable of capturing information, the device having at least one given parameter. Process 100 also comprises step 206 in which it is evaluated whether the device of step 204 is in a geographically defined zone or not, the zone having at least one configurable criterion. Step 208 provides for situations in which the device is not in a geographically defined zone by permitting all information gathering abilities of the device. Step 210 follows Step 206 in which a notification is sent to the information gathering device detailing that a geographically defined zone has been entered, and the permissions of the device. In place of Step 210, Step 212 will occur in which no notification is sent to the device. Process 200 also includes Step 214 which configures the software protocol to detect device permissions as evaluated by comparing the device parameter(s) and the geographically defined area criterion to permit access to camera features. After Step 214, Step 222 changes the software protocol to affect only audio recording features. Else, Step 216 configures the software protocol to detect device permissions as evaluated by comparing the device parameter(s) and the geographically defined area criterion to permit access to audio recording features. After Step 216, Step 224 changes the software protocol to affect only camera features. Also, Step 218 configures the software protocol to detect device permissions as evaluated by comparing the device parameter(s) and the geographically defined area criterion to permit access to both camera and audio recording features. After Step 218, Step 226 changes the software protocol to not affect information gathering features. Lastly, Step 220 configures the software protocol to detect device permissions as evaluated by comparing the device parameter(s) and the geographically defined area criterion to not permit access to information gathering features. After Step 220, Step 228 changes the software protocol to affect all information gathering features. The process embodiments of the invention ends at End Step 230. End Step 230 may comprise any number of steps or function performed after Steps 204 or 208.

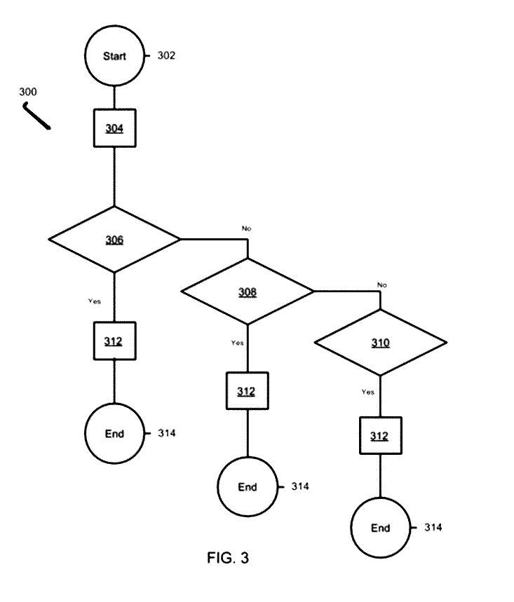

Referring now to FIG. 3, there is schematically represented a process 300 according to embodiments of the invention. The process begins with Start Step 302 which may comprise any number of prior steps or functions. Start Step 302 is followed by Step 304. Step 304 comprises detecting the activation of a non-permitted information capturing feature on an information capturing device with at least 1 parameter, and inside of a geographically defined area with at least one configurable criterion. Process 300 also includes step 306 which alters captured media during the capture process. Alternatively, media can be altered during the save process as in Step 308. Also, Step 310 details the alteration of media after the save process. Lastly, Step 312 describes the captured information being in an altered form by means of randomizing the information captured, deleting a portion of the information, or combining at least a portion of the information with additional information. The process embodiments of the invention ends at End Step 314. End Step 314 may comprise any number of steps or function performed after Step 312.

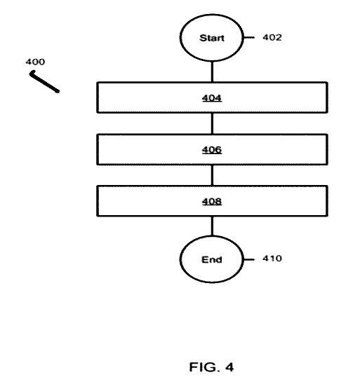

Referring now to FIG. 4, there is schematically represented a process 400 according to embodiments of the invention. The process begins with Start Step 402 which may comprise any number of prior steps or functions. Start Step 402 is followed by Step 404. Step 404 comprises detecting the activation of a non-permitted information capturing feature on an information capturing device with at least 1 parameter, and inside of a geographically defined area with at least one configurable criterion. Process 400 also includes step 406 which stores information other than the captured information on the information capturing device, and stores the captured information to a location not originally intended: local or remote. Lastly, Step 408 comprises the intended captured information not being accessible or able to be located on the information capturing device. The process embodiments of the invention ends at End Step 410. End Step 410 may comprise any number of steps or function performed after Step 410.

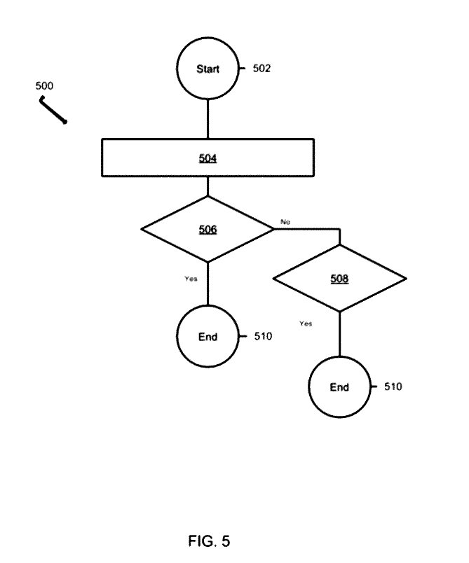

Referring now to FIG. 5, there is schematically represented a process 500 according to embodiments of the invention. The process begins with Start Step 502 which may comprise any number of prior steps or functions. Start Step 502 is followed by Step 504. Step 504 comprises detecting the activation of a non-permitted information capturing feature on an information capturing device with at least 1 parameter, and inside of a geographically defined area with at least one configurable criterion. Process 500 also includes step 506 in which a software protocol limits access to information gathering features on an information gathering device. Alternatively, Step 508 describes the process by which information capturing takes place via by means of an information capturing feature, but it is not saved. The process embodiments of the invention ends at End Step 510. End Step 510 may comprise any number of steps or function performed after Step 510.

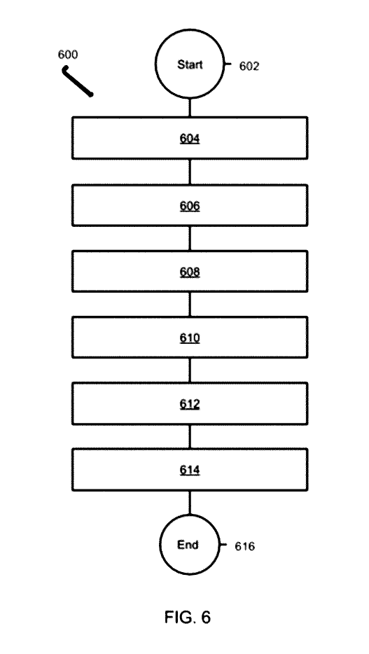

Referring now to FIG. 6, there is schematically represented a process 600 according to embodiments of the invention. The process begins with Start Step 602 which may comprise any number of prior steps or functions. Start Step 602 is followed by Step 604. Step 604 comprises defining a geographically defined zone with at least one configurable criterion around a point of interest. Process 600 also includes Step 606 in which a device capable of capturing information enters the geographically defined area. Following this, Step 608 comprises notifying the information capturing device of its entrance into the geographically defined area and its subsequent permissions, provided the geographically defined area is configured to behave as such. Step 610 details the software protocol selectively affecting information gathering elements as evaluated by comparing the device parameter(s) and the geographically defined area criterion to establish the behavior of the software protocol. Process 600 includes Step 612 as well in which the activation of an information capturing feature on an information capturing device occurs that is not permitted, and the information is altered or stored on another information capturing device, or the feature is disabled. Lastly, Step 614 describes the exiting of an information capturing device from the geographically defined zone, in which its permission to freely activate information gathering abilities is restored. The process embodiments of the invention ends at End Step 616. End Step 616 may comprise any number of steps or function performed after Step 614.

### EMBODIMENTS

Accordingly, the instant disclosure relates to the following embodiments:

### Embodiment A

A method of selectively permitting the capture of information, the method comprising the steps of:
(a) determining if a device capable of capturing information has entered a predetermined geographically defined zone, the zone having at least one configurable criterion;
(b) determining a parameter of the device; and
(c) selectively permitting, if the parameter of the device satisfies the at least one configurable criterion, an ability of the information capturing device to capture information when in the predetermined geographically defined zone.

### Embodiment B

The method of Embodiment A, wherein the at least one configurable criterion is selected from the group consisting of a location, a security level, a date, and a time.

### Embodiment C

The method of Embodiment A or B further comprising determining if the parameter of the device satisfies the at least one configurable criterion of the zone.

### Embodiment D

The method of any of Embodiments A to C, further comprising activating a software protocol on the information capturing device, the software protocol adapted to control one or more information capturing features of the capturing information device.

### Embodiment E

The method of any of Embodiments A to D, wherein selectively permitting an ability of the information capturing device to capture information comprises:
a) storing the information on the information capturing device in an altered form;
b) storing information other than the captured information on the information capturing device, and/or
c) disabling an information capturing feature of the capturing information device.

### Embodiment F

The method of Embodiment C, wherein storing the information in an altered form comprises randomizing the information, deleting at least a portion of the information, or combining at least a portion of the information with additional information.

### Embodiment G

The method of any of Embodiments A to F, wherein selectively permitting an ability of the information capturing device to capture information comprises storing the captured information on a remote storage device.

### Embodiment H

The method of Embodiment F, further including causing a notification of the storing the captured information on the remote storage device to be sent to the information capturing device.

### Embodiment I

The method of any of Embodiments A to I, further comprising, notifying the information capturing device that the geo-restricted area has been entered.

### Embodiment J

The method of Embodiment G, further comprising notifying the information capturing device of limitations of information capture related to the at least one configurable criterion.

### Embodiment K

The method of any of Embodiments A to J, wherein the one or more information capturing features comprises: a camera feature, an audio recording feature, or a screen capture feature.

### Embodiment L

The method of any of Embodiments A to K, wherein the information capturing device is selected from the group consisting of a cellular telephone, a tablet type computer, a laptop computer, and a desktop computer.

### Embodiment M

The method of any of Embodiments A to L, further comprising notifying an owner or administrator of the predetermined geographically defined zone that an information capturing device has entered the predetermined geographically defined zone.

### Embodiment N

An information capturing device configured to restrict the capture of information, the information capturing device comprising a) one or more information capturing features; and b) a software protocol configured to determine if the information capturing device has entered a geographically restricted zone and to selectively permit an ability of the information capturing device to capture information when in the information capturing device is within the predetermined geographically defined zone.

### Embodiment O

The information capturing device of Embodiment N, wherein the software protocol comprises an operating system protocol or an application level protocol.

### Embodiment P

The information capturing device of Embodiment N or O, wherein the one or more information capturing features comprises a camera feature, an audio recording feature, or a screen capture feature.

### Embodiment Q

The information capturing device of any of Embodiments N to P, further comprising a display and an information storage system.

### Embodiment R

The information capturing device of Embodiment Q, wherein software protocol is configured to: a) store on the information storage system in an altered form the information captured by the one or more information capturing features of the information capturing device; b) store on the information storage system information other than the information captured by the one or more information capturing features of the information capturing device, and/or c) disable at least one of the one or more information capturing features of the information capturing device.

### Embodiment S

The information capturing device of Embodiment R, wherein software protocol is configured to: a) randomize at least a portion of the information captured by the one or more information capturing features of the information capturing device; b) delete at least a portion of the information; and/or c) combine at least a portion of the information captured by the one or more information capturing features of the information capturing device with additional information.

### Embodiment T

The information capturing device of any of Embodiments N to S, wherein software protocol is configured to store the captured information on a remote storage device.

### Embodiment U

The information capturing device of Embodiment Q, wherein software protocol is configured to display a notice on the display that the information capturing device has entered a predetermined geographically defined zone.

### Embodiment V

The information capturing device of Embodiment Q or U, wherein software protocol is configured to display a notice on the display that the functionality of at least one of the one or more information capturing features of the information capturing device has been limited based on the at least one configurable criterion.

### Embodiment W

The information capturing device of any of Embodiments N to V, wherein the information capturing device is selected from the group consisting of a cellular telephone a cellular telephone, a tablet type computer, a laptop computer, and a desktop computer.

All documents described herein are incorporated by reference herein, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

What is claimed is:

1. A method of selectively permitting the capture of information, the method comprising the steps of:
(a) determining if a device capable of capturing information has entered a predetermined geographically defined zone, the zone having at least one configurable criterion;
(b) determining a parameter of the device; and
(c) selectively permitting, if the parameter of the device satisfies the at least one configurable criterion, an ability of the information capturing device to capture information when in the predetermined geographically defined zone.

2. The method of claim 1, wherein the at least one configurable criterion is selected from the group consisting of a location, a security level, a date, a time, and a predetermined event.

3. The method of claim 1 further comprising determining if the parameter of the device satisfies the at least one configurable criterion of the zone.

4. The method of claim 1, further comprising activating a software protocol on the information capturing device, the software protocol adapted to control one or more information capturing features of the capturing information device.

5. The method of claim 1, wherein selectively permitting an ability of the information capturing device to capture information comprises:
(a) storing the information on the information capturing device in an altered form;
(b) storing information other than the captured information on the information capturing device, or
(c) disabling an information capturing feature of the capturing information device.

6. The method of claim 3, wherein storing the information in an altered form comprises randomizing the information, deleting at least a portion of the information, or combining at least a portion of the information with additional information.

7. The method of claim 1, wherein selectively permitting an ability of the information capturing device to capture information comprises storing the captured information on a remote storage device.

8. The method of claim 5, further including causing a notification of the storing the captured information on the remote storage device to be sent to the information capturing device.

9. The method of claim 1, further comprising, notifying the information capturing device that the geo-restricted area has been entered.

10. The method of claim 6, further comprising notifying the information capturing device of limitations of information capture related to the at least one configurable criterion.

11. The method of claim 1, wherein the one or more information capturing features comprises: a camera feature, an audio recording feature, or a screen capture feature.

12. The method of claim 1, wherein the information capturing device is selected from the group consisting of a cellular telephone, a tablet type computer, a laptop computer, and a desktop computer.

13. The method of claim 1, further comprising notifying an owner or administrator of the predetermined geographically defined zone that an information capturing device has entered the predetermined geographically defined zone.

14. An information capturing device configured to restrict the capture of information, the information capturing device comprising:
(a) one or more information capturing features; and
(b) a software protocol configured to determine if the information capturing device has entered a geographically restricted zone and to selectively permit an ability of the information capturing device to capture information when in the information capturing device is within the predetermined geographically defined zone.

15. The information capturing device of claim 12, wherein the software protocol comprises an operating system protocol or an application level protocol.

16. The information capturing device of claim 12, wherein the one or more information capturing features comprises a camera feature, an audio recording feature, or a screen capture feature.

17. The information capturing device of claim 12, further comprising a display and an information storage system.

18. The information capturing device of claim 15, wherein software protocol is configured to:
(a) store on the information storage system in an altered form the information captured by the one or more information capturing features of the information capturing device;
(b) store on the information storage system information other than the information captured by the one or more information capturing features of the information capturing device, and/or
(c) disable at least one of the one or more information capturing features of the information capturing device.

19. The information capturing device of claim 16, wherein software protocol is configured to:
(a) randomize at least a portion of the information captured by the one or more information capturing features of the information capturing device;
(b) delete at least a portion of the information; and/or
(c) combine at least a portion of the information captured by the one or more information capturing features of the information capturing device with additional information.

20. The information capturing device of claim 12, wherein software protocol is configured to store the captured information on a remote storage device.

21. The information capturing device of claim 15, wherein software protocol is configured to display a notice on the display that the information capturing device has entered a predetermined geographically defined zone.

22. The information capturing device of claim 15, wherein software protocol is configured to display a notice on the display that the functionality of at least one of the one or more information capturing features of the information capturing device has been limited based on the at least one configurable criterion.

23. The information capturing device of claim 12, wherein the information capturing device is selected from the group consisting of a cellular telephone a cellular telephone, a tablet type computer, a laptop computer, and a desktop computer.
